(19) United States
(12) Patent Application Publication
(10) Pub. No.: US 2011/0220850 A1
(43) Pub. Date: Sep. 15, 2011

(54) Solutions Of Conductive Molecular Materials And Electromagnetic Absorbent Materials Produced From These Solutions

(75) Inventors: Matthieu Souque, Toulouse (FR); Olivier Vendier, Lacroix-Falgarde (FR); Lydie Valade, Cugnaux (FR); Dominique De Caro, Toulouse (FR); Jean-Michel Desmarres, Dremil-LaFage (FR); Frédéric Courtade, Castanet (FR)

(73) Assignees: THALES, Neuilly-sur-Seine (FR); CENTRE NATIONAL D'ETUDES SPATIALES CNES, Paris (FR); CENTRE NATIONAL DE LA RECHERCHE SCIENTIFIQUE, Paris (FR)

(21) Appl. No.: 13/045,336

(22) Filed: Mar. 10, 2011

(30) Foreign Application Priority Data
Mar. 12, 2010 (FR) 10 01003

(51) Int. Cl. H01B 1/12; B05D 3/02

(52) U.S. Cl. 252/500; 427/384

(57) ABSTRACT

A stable solution of molecular material includes a first type of organic or organometallic molecule and a second type of organic or organometallic molecule or of ion. The first type has groups allowing electron delocalization. The solution further includes a third type of molecule that may be a surfactant or a solvent, capable of combining with the first or the second type of molecule or of ion), to form an adduct in solution whose presence prevents the precipitation of a compound formed by reaction between the first and second types of molecules, and makes it possible to obtain solutions whose concentration of the compound is greater than that governed by the precipitation constant of the compound in the absence of molecules of the third type.

The field of the invention is that of molecular materials, which may find many uses in fields such as electromagnetic absorbent materials or materials for electronics (transistors, tracks, LED, data storage, etc.).

More specifically, such materials are notably sought for their conductive and magnetic properties in spatial applications, and more specifically for RF absorbers with dielectric losses above 20 GHz. For this, it is necessary to have available materials that satisfy all of the following criteria:

a conductivity of between 1 and 1000 S·m⁻¹ above 20 GHz;

deposition possible on complex geometries (protruding angles, etc.);

substantial lightness for the onboard material;

a controllable deposit thickness;

good behaviour in a spatial environment.

Electromagnetic absorbent materials comprising electrical-loss composites charged with conductive particles or comprising magnetic-loss composites charged with magnetic particles are currently known. Thus, broad-band absorbers exist, of the type: low electrical-loss or magnetic-loss foams (carbon black, silicon carbide, ferrite, etc. filler content of less than 1%). However, they give rise to large thicknesses greater than about 3 mm and also require implementation notably by plates bonded to the metallic case.

It has also been proposed to make resonant absorbers from composite materials with high electrical losses or high magnetic losses that use higher filler contents than broad-band electromagnetic absorbent materials. Resonant magnetic absorbent materials have problems of density (at least greater than 3.6 g·cm⁻³) and of cut-off frequency. Specifically, beyond a certain frequency, the absorbent material made with such particles no longer has absorbent properties. This problem is typically encountered for frequencies above about a hundred gigahertz.

Electrical resonant absorbent materials require great control of dispersion of the fillers: since the particles used (such as carbon black) are highly conductive, it is necessary to have a filler content located in the percolation zone of the material and thus very finely to control the concentrations of particle contents.

In this context, the present invention exploits the ability to produce materials of moderated conductivity in order to avoid the problem of an excessively abrupt percolation threshold, and proposes to use molecular materials that are easy to implement.

In general, molecular materials are defined by their structure. They are more specifically materials formed from molecular bricks that are organic molecules or transition metal complexes composed of one or more cations and of organic ligands. The nature of these bricks and their organization make it possible to obtain materials with novel physical properties notably in terms of conductivity, ferromagnetism or alternatively photochromism.

The best-known molecular conductors are conductive polymers. The conductivity of these polymers depends just like semiconductor materials on their level of doping and on the amount of free fillers present on the chain. One of the drawbacks that they have lies in their lack of stability over time, which is a cause of filler neutralization (for example in a humid atmosphere or under UV exposure).

Conductive molecular materials formed solely from organic or organometallic molecules (which are not polymers) also exist. These compounds are generally obtained in the form of monocrystals that intrinsically have high conductivity values (between 1 and 100 000 S·m⁻¹) and conserve their electrical properties for more than fifteen years. These materials are relatively brittle and are usually used in the form of deposits. These materials are sparingly soluble and these depositions on surfaces are generally performed by electrodeposition, CVD, or successive depositions of solutions of precursors. All these techniques make it possible to obtain only thin deposits on reduced surfaces and are more or less rapid.

Direct deposition on a substrate performed by deposition of a solution “spin coating” or by impregnation “dip coating”, or alternatively by immersion in a solution of molecular conductor, was hitherto very limited by the very low maximum concentrations of the solutions: for example, in DMSO, a precursor such as TTF has a solubility of 770 g/L, a precursor such as TCNQ has a solubility of 16 g/L and the conductive molecular compound TTF•TCNQ has a solubility of 0.8 g/L. This concentration does not make it possible to make direct deposits, all the more so since, for these very low concentrations, deterioration of the compound may take place during drying.

To overcome the problem of dissolution in a solvent of the above-mentioned molecular materials, in order notably to facilitate the manufacture of films, the present invention provides a solution to the problem of producing stable colloidal solutions with high concentrations of molecular materials. In this form, the solution may be directly deposited onto a substrate in order to obtain a film, or may be combined with a precursor solution of a matrix to obtain nanostructured composite materials of optimum homogeneity.

More specifically, one subject of the present invention is a stable solution of molecular material, characterized in that it comprises:

a first type of organic or organometallic molecule M1;

a second type of organic or organometallic molecule or of ion M2;

the first type at least having groups allowing electron delocalization;

a third type of molecule M3 that may be a surfactant or a solvent, capable of combining with the first or the second type of molecule or of ion M1, M2, to form an adduct in solution whose presence prevents the precipitation of the compound M1-M2 formed by reaction between M1 and M2 and makes it possible to obtain a solution whose concentration of compound M1-M2 is greater than that governed by the precipitation constant of the compound M1-M2 in the absence of molecules of the third type M3.

The solution of the present invention may typically be stable without any precipitation being observed for at least three months.

According to one variant of the invention, the solution also comprises a fourth type of molecule M4, which may be a surfactant or a solvent, capable of combining with the first and the second types of organic or organometallic molecule.

According to one variant of the invention, the first or second type of molecule is an organic or organometallic molecule, or an organic or organometallic molecular salt.

According to one variant of the invention, the third and/or fourth type of molecule is a compound comprising functions of amine or carboxylic acid or phosphine type or molecules bearing a π coordinating system.

According to one variant of the invention, the first and/or second type of molecule or of ion is an organic or organometallic molecule of donor type, which may be of the type such as:

TTF derivative;

transition metal complexes;

complexes of metals with bisdithiolene ligands: M(dmit)₂ in neutral or charged state with M: Ni, Pd, Pt and dmit: 4,5-dimercapto-1,3-dithiole-2-thione;

complexes of metals with ligands of TTF-bisdithiolene type such as tmdt: M(tmdt)₂ in neutral or charged state with tmdt: trimethylenetetrathiafulvalene-dithiolate and M: Ni, Pd, Pt;

complexes of metals with dcbdt ligands: M(dcbdt)₂, in neutral or charged state with dcbdt: dicyanobenzenedithiolate and M: Ni, Pd, Pt;

perylene.

According to one variant of the invention, the first and/or second type of molecule is an organic or organometallic molecule of acceptor type, which may be of the type such as:
a TCNQ derivative: tetracyano-p-quinodimethane;

TNAP: 11,11,12,12-tetracyanonaphtho-2,6-quinodimethane;

DCNQI: dicyanoquinonediimine.

According to one variant of the invention, when only one first type or second type is of the organic or organometallic molecule type, the other type may be of ionic type and may be included among one of the following anions: hexafluorophosphates, triiodide, chloride, bromide, arseniates, antimoniates.

According to one variant of the invention, when only one first type or second type is of organic or organometallic molecule type, the other type may be of ionic type and may be included among one of the following cations: Na⁺ (sodium), K⁺ (potassium) or a transition metal cation.

According to one variant of the invention:

the molecules of the first type are TTF molecules;

the molecules of the second type are TCNQ molecules;

the molecules of the third type are long-carbon-chain amine molecules.

According to one variant of the invention:

the molecules of the first type are TTF molecules;

the molecules of the second type are TCNQ molecules;

the molecules of the third type are long-carbon-chain amine molecules.

A subject of the invention is also a process for preparing a stable solution of molecular material according to the invention, characterized in that it includes the mixing of a first type of organic or organometallic molecule M1 and of a second type of organic or organometallic molecule or of ion M2, the first type at least having groups allowing electron delocalization, and being capable of forming a molecular crystal, in the presence of at least a third type of molecule M3 which may be a surfactant or a solvent, capable of combining with the first or with the second type of molecule or of ion M1, M2, to form an adduct in solution whose presence prevents the precipitation of the compound M1-M2 formed by reaction between M1 and M2 and makes it possible to obtain a solution whose concentration of compound M1-M2 is greater than that governed by the precipitation constant of the compound M1-M2 in the absence of molecules of the third type M3.

According to one variant of the invention, the process includes the addition of a third type of molecule M3 and of a fourth type of molecule M4 which may be a surfactant or a solvent, capable of combining with the first and the second types of organic or organometallic molecule M1, M2.

According to one variant of the invention, the process comprises the following steps:
the mixing of TTF molecules and of long-carbon-chain amine molecules in an organic solvent, so as to obtain a primary mixture;
the addition of TCNQ molecules in an organic solvent to the primary mixture.

According to one variant of the invention, the process comprises the following steps:
the mixing of TTF₃(BF₄)₂ molecules and of long-carbon-chain amine molecules in an organic solvent, so as to obtain a primary mixture;
the addition of [(n-C₄H₉)₄N][Ni(dmit)₂] molecules in an organic solvent to the primary mixture.

A subject of the invention is also a process for preparing a nano-particulate powder of molecular material, characterized in that it is obtained by drying a stable solution of molecular material according to the invention.

A subject of the invention is also a process for manufacturing a film based on molecular material, characterized in that it includes the deposition of a stable solution of molecular material according to the invention onto a support, followed by the drying of the said solution.

A subject of the invention is also a process for manufacturing a composite material based on molecular material, characterized in that it includes the mixing of a stable solution according to the invention with an organic or inorganic matrix.

A subject of the invention is also a process for manufacturing a composite material based on molecular material, characterized in that it includes the mixing of a nanometric powder obtained via the process of the invention with an organic or inorganic matrix.

A subject of the invention is also the use of a stable solution of molecular material according to the invention for the preparation of an electromagnetic absorbent material.

A subject of the invention is also the use of a stable solution of molecular material according to the invention for the preparation of an active material for electronics. It may notably be a conductive track or a transistor or a light-emitting diode.

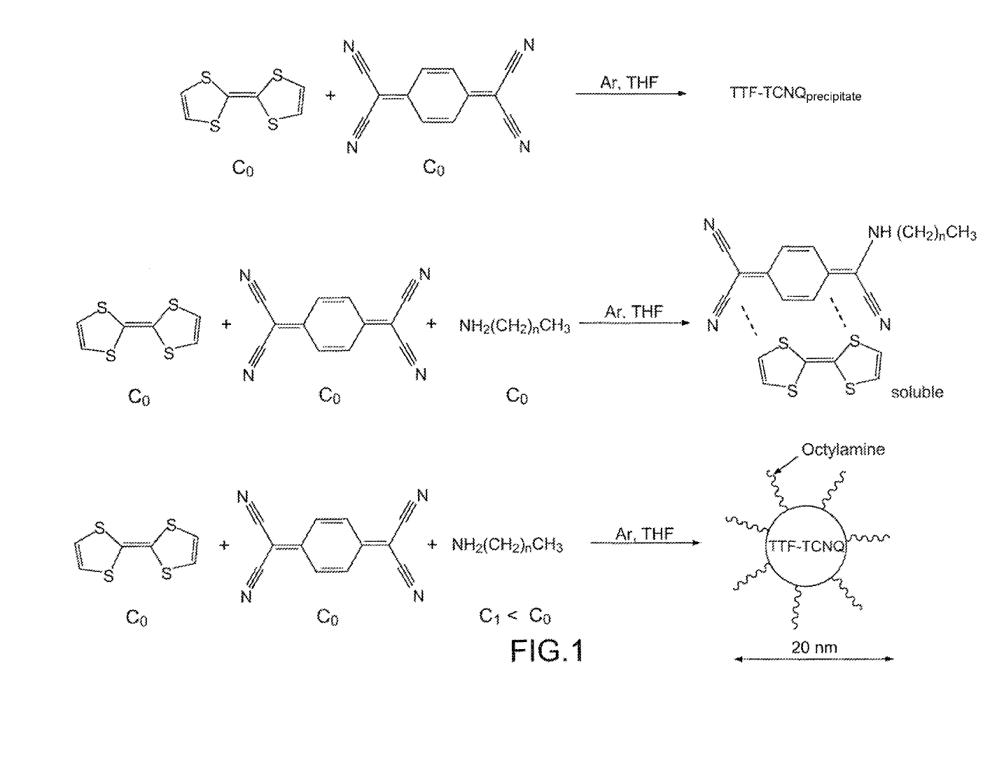

The invention will be understood more clearly and other advantages will emerge on reading the description that follows, which is given without any limitation and by means of the attached FIG. 1 relating to an example of an adduct formed in a solution of conductive molecular materials of the invention.

In general, the first molecular types M1 and M2 play equivalent roles and may be of simple organic or organometallic molecule, molecular salt or inorganic salt type. To satisfy the present invention, it is also necessary to use a third molecule type M3 which may be a surfactant or even a solvent, capable of combining with one of the types M1 or M2, to form an adduct in solution, an adduct corresponding in a known manner to a species formed by direct combination of a type M1 and of a type M3, or of a type M2 and of a type M3.

Specifically, the present invention proposes to combine the first and second types of molecule M1 or M2 with a third type of molecule M3, which makes it possible to avoid the possibility that, in a solvent, the placing in contact of M1 and M2 causes precipitation of the insoluble molecular conductor M1-M2, the formation of the solid precipitate being liable to result from a redox reaction or from a charge-transfer reaction. The stable solution resulting from the combination of M1, M2 and M3 may then contain molecular adducts comprising two of the three species or the three species fully dispersed in solution or nanoparticles of the compound M1-M2 stabilized by M3.

To overcome this problem in the context of the present invention, the molecules of the type M1 or M2 may also be combined with a type of molecule M3 and with a type of molecule M4 to lead to two soluble adducts.

Moreover, the molecules of the type M1 and the molecules of the type M3 or the molecules of the type M2 and the molecules of the type M3 must be soluble in the same solvent. The solvation may result from the interaction between the molecules of the type M1 and the molecules of the type M3 or the molecules of the type M2 and the molecules of the type M3.

The solvents for the adducts M1 and M3 and for the molecules M2 or the solvents for the adducts M2 and M3 may be identical or different.

### Examples of Molecules of the Type M1 and/or of the Type M2

1) Molecules of Donor Type:

1.1. TTF (tetrathiafulvalene) derivatives, MDT-TTF (methylenedithiotetrathiafulvalene), BMDT-TTF (bis(methylenedithio)tetrathiafulvalene), BPDT-TTF (bis(propylenedithio)tetrathiafulvalene), DMET (dimethyl(ethylenedithio)diselenadithiafulvalene), HMTSF (hexamethylenetetraselenafulvalene), TMTTF (tetramethyltetrathiafulvalene), TMTSF (tetramethyltetraselenafulvalene), BEDT-TTF (bis(ethylenedithio)tetrathiafulvalene).

1.2. Transition Metal Complexes

1.3. Family of bisdithiolene metal complexes, for instance: M(dmit)₂ in neutral or charged state, with M: Ni, Pd, Pt and dmit: 4,5-dimercapto-1,3-dithiole-2-thione.

1.4. Family of complexes of metals with ligands of the type TTF-bisdithiolene, for instance tmdt: M(tmdt)₂ in neutral or charged state with tmdt: trimethylenetetrathiafulvalene-dithiolate and M: Ni, Pd, Pt.

1.5. Family of complexes of metals with ligands dcbdt M(dcbdt)₂ in neutral or charged state with dcbdt: dicyanobenzenedithiolate and M: Ni, Pd, Pt.

1.6. Perylene

2) Molecules of Acceptor Type which May be:

TCNQ derivatives: tetracyano-p-quinodimethane;

TNAP: 11,11,12,12-tetracyanonaphtho-2,6-quinodimethane;

DCNQI: dicyanoquinonediimine.

When the solution comprises only a first type M1 or M2 mentioned above, the other species may be of ionic type and, in this case, the said ions may be:

3) Anions:

PF₆⁻ (hexafluorophosphates)

I₃⁻ (triiodide)

Cl⁻ (chloride)

Br⁻ (bromide)

AsF₆⁻ (arseniates)

SbF₆⁻ (antimoniates)

4) Cations

Na⁺ (sodium)

K⁺ (potassium)

Transition metal cations

### Examples of Molecules of the Type M3 and of the Type M4

In general, the third and fourth types of molecule charged with defining the adducts in solution with the first or second types of molecule may be organosoluble bearing at least one coordinating group. They may notably be compounds comprising the following functions:

amines (example: 1-octylamine, 1-pentylamine);

carboxylic acids;

esters;

siloxanes;

phosphines;

molecules bearing a π coordinating system (example: 3-hexylthiophene).

In general, the protocol for obtaining a colloidal solution of molecular conductors is as follows:

Two types of constituent molecules which, in the presence of each other, spontaneously form the molecular conductor, should be selected. A solution containing, on the one hand, the first type of molecule M1 also containing a third type of molecule M3 of surfactant type (the surfactant may be the solvent itself) is prepared in a reactor.

The second type of molecule M2 dissolved in a volume of solvent in the reaction medium is then added with magnetic stirring. The reaction takes place at room temperature. The concentrations of reagents and surfactants will determine the size of the particles formed and their stability in solution. Typically, the size of the particles thus formed may be of the order of a few nanometres, or even a few tens of nanometres.

These colloidal solutions may then be dried to obtain a nanoparticulate powder of molecular conductor, which may be redissolved or dispersed according to the solvents used.

The ease of implementation afforded by these colloidal solutions is very great. Such solutions allow uniform incorporation into matrices and deposition via processes such as spin coating or spraying that are impossible according to the known techniques of the prior art on account of the low concentrations of the molecular conductor solutions.

In-situ synthesis furthermore avoids the need for separate synthesis and dispersion steps.

First Example of a Process for Preparing a Solution Comprising Conductive Molecular Materials

By way of example, FIG. 1 illustrates the scheme for the synthesis of stable colloidal solutions of TTF-TCNQ, a molecular material with a conductivity of 190 000 S·m⁻¹ on a monocrystal and which makes it possible typically to obtain a solution of molecular materials according to the invention.

In a first step, preparation of a primary mixture of molecules of the type M1 of TTF (concentration of between 0.1 and 10 g/L) and of molecules of the type M3 of saturated or unsaturated carbon-chain amines (concentration of between 0.1 and 20 g/L) is performed in an organic solvent. In parallel, molecules of the type M2 of TCNQ are placed in another organic solvent (which may be identical, concentration of between 0.1 and 20 g/L). The solution containing M2 is then added to that containing M1 to obtain the solution of the invention. This solution may be concentrated by evaporation without precipitation.

The conductivity of the films obtained by direct deposition is 20 S·m⁻¹.

The use of a smaller number of equivalents of amine makes it possible to obtain nano-yarns and nanoparticles that are stable in solution.

Second Example of a Process for Preparing a Solution Comprising Conductive Molecular Materials

Molecules of the first type M1 of TTF₃(BF₄)₂ (concentration of between 0.1 and 10 g/L) are mixed with molecules of the third type of saturated or unsaturated long-carbon-chain amine (concentration of between 0.1 and 10 g/L) in an organic solvent. This mixture is added to a solution in another organic solvent of molecules of the second type of [(n-C₄H₉)₄N][Ni(dmit)₂] (concentration between 0.1 and 10 g/L) to obtain the solution of the invention.

The conductivity of the films obtained by direct deposition is 200 S·m⁻¹.

1. A stable solution of molecular material, comprising:
a first type of organic or organometallic molecule (M1);
a second type of organic or organometallic molecule or of ion (M2);
the first type at least having groups allowing electron delocalization;
a third type of molecule (M3) that may be a surfactant or a solvent, capable of combining with the first or the second type of molecule or of ion (M1, M2), to form an adduct in solution whose presence prevents the precipitation of the compound M1-M2 formed by reaction between M1 and M2 and makes it possible to obtain a solution whose concentration of compound M1-M2 is greater than that governed by the precipitation constant of the compound M1-M2 in the absence of molecules of the third type M3.

2. The stable solution of molecular material according to claim 1, further comprising a fourth type of molecule (M4), which may be a surfactant or a solvent, capable of combining with the first and the second types of organic or organometallic molecule (M1, M2).

3. The stable solution of molecular material according to claim 1, wherein the first or second type of molecule is an organic or organometallic molecule, or an organic or organometallic molecular salt.

4. The stable solution of molecular material according to claim 1, wherein one or more of the third and fourth type of molecule (M3, M4) is a compound comprising functions of amine or carboxylic acid or phosphine type or molecules bearing a π coordinating system.

5. The stable solution of molecular material according to claim 1, wherein one or more of the first and second type of molecule or of ion (M1, M2) is an organic or organometallic molecule of donor type, comprising one or more of:
TTF derivative;
transition metal complexes;
complexes of metals with bisdithiolene ligands: M(dmit)₂ in neutral or charged state with M: Ni, Pd, Pt and dmit: 4,5-dimercapto-1,3-dithiole-2-thione;
complexes of metals with ligands of TTF-bisdithiolene type such as tmdt: M(tmdt)₂ in neutral or charged state with tmdt: trimethylenetetrathiafulvalene-dithiolate and M: Ni, Pd, Pt;
complexes of metals with dcbdt ligands: M(dcbdt)₂, in neutral or charged state with dcbdt: dicyanobenzenedithiolate and M: Ni, Pd, Pt; and
perylene.

6. The stable solution of molecular material according to claim 1, wherein one or more of the first and second type of molecule (M1, M2) is an organic or organometallic molecule of acceptor type, comprising one or more of:
a TCNQ derivative: tetracyano-p-quinodimethane;
TNAP: 11,11,12,12-tetracyanonaphtho-2,6-quino dimethane; and
DCNQI: dicyanoquinonediimine.

7. The stable solution of molecular material according to claim 1, wherein when only one first type or second type is of the organic or organometallic molecule type, the other type may be of ionic type and may be included among one of the following anions: hexafluorophosphates, triiodide, chloride, bromide, arseniates, antimoniates.

8. The stable solution of molecular material according to claim 1, wherein when only one first type or second type is of organic or organometallic molecule type, the other type may be of ionic type and may be included among one of the following cations: Na+ (sodium), K+ (potassium) or a transition metal cation.

9. The stable solution of molecular material according to claim 1, wherein:
the molecules of the first type are TTF molecules;
the molecules of the second type are TCNQ molecules; and
the molecules of the third type are long-carbon-chain amine molecules.

10. The stable solution of molecular material according to claim 2, wherein:
the molecules of the first type are TTF molecules;
the molecules of the second type are TCNQ molecules; and
the molecules of the third type are long-carbon-chain amine molecules.

11. A process for preparing a stable solution of molecular material according to claim 1, said process comprising the mixing of the first type of organic or organometallic molecule (M1) and of the second type of organic or organometallic molecule or of ion (M2), the first type at least having groups allowing electron delocalization, and being capable of forming a molecular crystal, in the presence of at least the third type of molecule (M3) which may be a surfactant or a solvent, capable of combining with the first or with the second type of molecule or of ion (M1, M2), to form an adduct in solution whose presence prevents the precipitation of the compound M1-M2 formed by reaction between M1 and M2 and makes it possible to obtain a solution whose concentration of compound M1-M2 is greater than that governed by the precipitation constant of the compound M1-M2 in the absence of molecules of the third type M3.

12. The process for preparing a stable solution of molecular material comprising molecular materials according to claim 11, further comprising the addition of the third type of molecule (M3) and of the fourth type of molecule (M4) which may be a surfactant or a solvent, capable of combining with the first and the second types of organic or organometallic molecule (M1, M2).

13. The process for preparing a stable solution of molecular material according to claim 11, the following steps:
the mixing of TTF molecules and of long-carbon-chain amine molecules in an organic solvent, so as to obtain a primary mixture; and
the addition of TCNQ molecules in an organic solvent to the primary mixture.

14. The process for preparing a stable solution of molecular material according to claim 11, further comprising:
the mixing of TTF₃(BF₄)₂ molecules and of long-carbon-chain amine molecules in an organic solvent, so as to obtain a primary mixture; and
the addition of [(n-C₄H₉)₄N][Ni(dmit)₂] molecules in an organic solvent to the primary mixture.

15. A process for preparing a nanoparticulate powder of molecular material, said method comprising drying a stable solution of molecular material according to claim 1.

16. A process for manufacturing a film based on molecular material, said process comprising the deposition of a stable solution of molecular material according to claim 1 onto a support, followed by the drying of the said solution.

17. A process for manufacturing a composite material based on molecular material, said process comprising the mixing of a stable solution according to one claim 1 with an organic or inorganic matrix.

18. A process for manufacturing a composite material based on molecular material, said process comprising the mixing of a nanometric powder obtained via the process of claim 15 with an organic or inorganic matrix.

19. A process for the preparation of an electromagnetic absorbent material, said process comprising using a stable solution of molecular material according to claim 1.

20. A process for the preparation of an active material for electronics, said process comprising using a stable solution of molecular material according to claim 1.

21. A process for the preparation of a conductive track or a transistor or a light-emitting diode, said process comprising using a stable solution of molecular material according to claim 1.
